(19) United States
(12) Patent Application Publication
(10) Pub. No.: US 2006/0129314 A1
(43) Pub. Date: Jun. 15, 2006

(54) Navigation system

(75) Inventor: Kim Gi Ryoong, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/299,194

(22) Filed: Dec. 9, 2005

(30) Foreign Application Priority Data
Dec. 9, 2004 (KR) 10-2004-0103313

(51) Int. Cl. G01C 21/30

(52) U.S. Cl. 701/209

(57) ABSTRACT

A navigation system is provided. The navigation system includes a path analyzer, a weight generator, an algorithm pre-processor, a genetic algorithm processor, and a path selector. The path analyzer combines a plurality of inputted intermediate point information to analyze movement path information, and the weigh generator generates weight information according to duration between the intermediated points. The algorithm pre-processor combines the intermediate point information to generate an initial solution group. The genetic algorithm processor generates a new candidate solution using a candidate solution contained in the initial solution group and replaces a candidate solution contained in the initial solution group by the new candidate solution depending on movement path information of the new candidate solution. The path selector selects a candidate solution having optimized movement path information from the candidate solutions contained in the solution group.

This application claims the benefit of the Korean Patent Application No. 10-2004-0103313, filed on Dec. 9, 2004, which is hereby incorporated by reference as if fully set forth herein.

### BACKGROUND OF THE INVENTION

1. Field of the Invention

The present invention relates to a navigation system.

2. Description of the Related Art

Vehicles provide intelligent services while transcending a simple function as a transport means by mounting an intelligent system such as a telematics terminal.

One of service systems developed earliest and widely used up to now among such intelligent service systems is a navigation system.

A navigation system is intended for providing an automatic navigation function to a vehicle using global positioning system (GPS) satellites and a GPS receiver. The navigation system gradually is expanding a service area thereof by cooperating with a geographic information system (GIS) based on location information.

A commercial navigation system provides a user with lots of geographic information besides simple location information. For example, the commercial navigation system may provide traffic and geographic information that reflects traffic information and accident status.

The GPS, which is a satellite-based position locating system using satellites, includes twenty four satellites, a control station of an earth station, a mobile station, and a stationary station. It is possible to know location data of any location on the earth using the GPS.

Generally, the navigation system uses a code division multiple access (CDMA) and transmits location information through a frequency channel having a spread bandwidth of 1.23 MHz per frequency alignment (FA).

When a user inputs a departure point, a current location, and a destination, the related art navigation system explores routes on the basis of exploration logic set in advance such as a shortest traveling distance, an expressway, a toll road, a national road priority. Next, when a user selects one of the explored routes, the navigation system guides a user with geographic information using a display and voices on the basis of the selected explored route until a user reaches a destination.

However, when a route is explored using only limited exploration logic and exploration data, it is not possible to satisfy a user's various preferences.

Particularly, the related art navigation system is useful to some extent in exploring an optimized path between two points, but may not be useful when a user must travel a plurality of intermediate points.

That is, the related art navigation system may be appropriately utilized in a region a user has previously experienced but may not be properly utilized in a region a user has not experienced. For example, a user requires much time even when determining a traveling sequence.

A user frequently rides a vehicle and travels a plurality of points in real life, and particularly, a user frequently face such a problem when carrying out his role in various businesses such as delivering goods, providing after-service, and checking instrument panels scattered over lots of places.

A problem of determining a sequence of a plurality of intermediate points is related to a mathematical algorithm called traveling salesperson problem (TSP). However, it is almost impossible to solve the TSP using a deterministic algorithm within a linear time.

### SUMMARY OF THE INVENTION

Accordingly, the present invention is directed to a navigation system that substantially obviates one or more problems due to limitations and disadvantages of the related art.

An object of the present invention is to provide a navigation system that more sufficiently reflects a circumstance and matches with a preference of a user by exploring sequences of intermediate points using non-linear algorithm without exploring a path using a deterministic algorithm that combines limited information when traveling a plurality of intermediate points.

Another object of the present invention is to provide a navigation system capable of guiding movement path information having highest reliability by reflecting as much as possible distance information, traffic information, and street status information obtained in the related art on the base of a probability theory even when a user has no knowledge for part of a region.

A further another object of the present invention is to provide a navigation system that allows a shortest time to be consumed and a movement distance to be short by exploring distance information using a non-linear algorithm when a sequence of intermediate points is not determined at all or when only a sequence between some intermediate points is determined.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a navigation system including: a path analyzer for combining a plurality of inputted intermediate point information to analyze movement path information; a weight generator for generating weight information according to a movement duration between intermediate points; an algorithm pre-processor for combining the intermediate point information to generate an initial solution group; a genetic algorithm processor for generating a new candidate solution using a candidate solution contained in the initial solution group and replacing the candidate solution contained in the initial solution group by the new candidate solution depending on movement path information of the new candidate solution; and a path selector for selecting a candidate solution having optimized movement path information from candidate solutions contained in the solution group.

In another aspect of the present invention, there is provided a method for selecting a path in a navigation system, the method including: generating a solution group consisting of a plurality of candidate solutions each combining a plurality of intermediate points; generating a new candidate solution by exchanging some of the intermediate points contained in the candidate solution; replacing the candidate solution contained in the solution group by the new candidate solution depending on movement path information of the new candidate solution; and selecting a candidate solution having optimized movement path information from the candidates contained in the solution group.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic block diagram of a navigation system according to an embodiment of the present invention;

FIG. 2 is a schematic block diagram of a GPS receiver in a navigation system according to an embodiment of the present invention;

FIG. 3 is a view illustrating an example of a pseudo-code of a genetic algorithm used by an exploring server in a navigation system according to an embodiment of the present invention;

FIG. 4 is a view illustrating an example of a data table generated by an exploring server in a navigation system according to an embodiment of the present invention;

FIG. 5 is a view illustrating an example where a path analyzer analyzes movement path information using a weighted graph method in a navigation system according to an embodiment of the present invention;

FIG. 6 is a view illustrating an example where an exploring server encoding intermediate point information symbol-coded for location information as a initial group on the basis of the location information in a navigation system according to an embodiment of the present invention;

FIG. 7 is an exemplary view illustrating a process for generating, at an exploring server, an initial solution group to apply a genetic algorithm to the initial solution group in a navigation system according to an embodiment of the present invention; and

FIG. 8 is a flowchart of a method for selecting a path in a navigation system according to an embodiment of the present invention.

### DETAILED DESCRIPTION OF THE INVENTION

Reference will now be made in detail to the preferred embodiments of the present invention, examples of which are illustrated in the accompanying drawings.

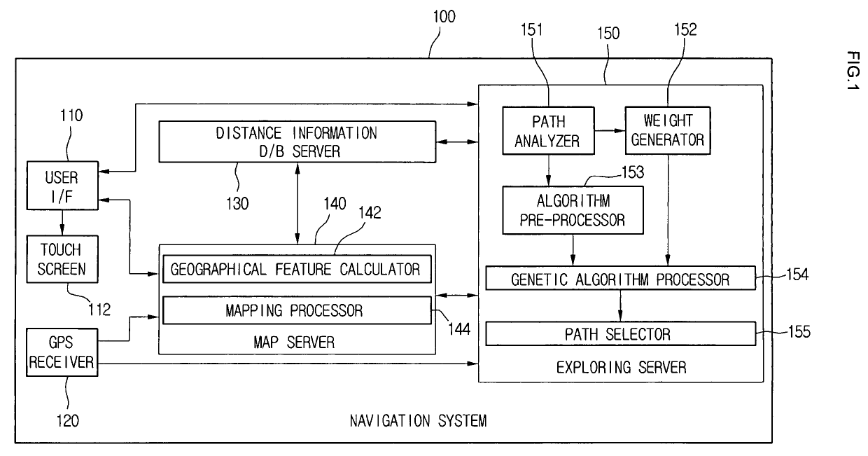

FIG. 1 is a schematic block diagram of a navigation system according to an embodiment of the present invention.

Referring to FIG. 1, the navigation system 100 includes a user interface 110, a global positional system (GPS) receiver 120, distance information database (DB) server 130, a map server 140, and an exploring server 150.

The user interface 110 may include a touch screen 112 and is connected to the map server 140 and the exploring server 150.

The user interface 110 receives intermediate point information from a user, displays the inputted intermediate point information on a screen so that a user may check the intermediate point information, and displays explored movement path information on the screen so that a user may use the movement path information.

Though the user interface 110 may further include an interface device such as a keypad and a speech recognition processing module besides the touch screen 112, the description is made for the case where only the touch screen 112 is provided for convenience.

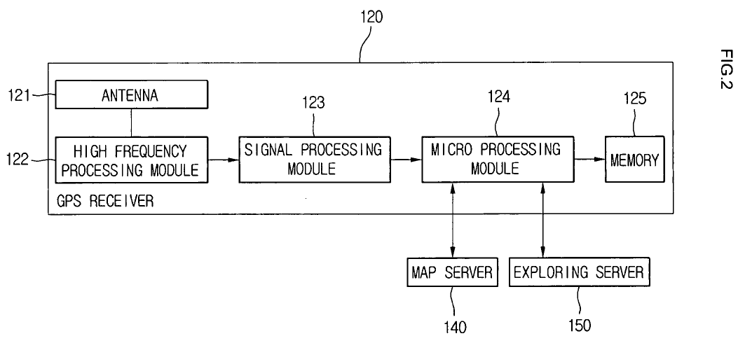

FIG. 2 is a schematic block diagram of a GPS receiver in a navigation system according to an embodiment of the present invention.

Referring to FIG. 2, the GPS receiver 120 includes an antenna 121, a high-frequency wave processing module 122, a signal processing module 123, a micro processing module 124, and a memory 125.

The high-frequency wave processing module 122 is connected to the antenna 121 and converts GPS satellite signals of high frequencies received from the antenna 121 into GPS satellite signals of intermediate frequencies.

Antenna 121 used for the GPS receiver 120 includes an orthogonal dipole antenna, a helical antenna, and a microstrip antenna. According to an embodiment of the present invention, a microstrip antenna having a small size may be used.

The signal processing module 123 is connected with the high-frequency wave processing module 122 and recovers the converted GPS satellite signals of intermediate frequencies into original signals to separate the GPS satellite signals into carrier waves, navigation messages, and codes transmitted from the satellites. The signal processing module 123 also extracts navigation messages transmitted from the satellites and calculates pseudo distances using reverse spreading, which recovers the GPS satellite signals transmitted through spectrum spreading into original signals. The navigation messages include one frame having a size of 1,500 bits, which is transmitted at a speed of 50 bits/sec.

One frame of the navigation message includes five subframes. First three subframes have the same contents but the fourth and fifth subframes have almanac (individual information) for each satellite. Here, the almanac is a variable bundle contained in the navigation message and is used for the GPS receiver 120 calculating the location of the satellites.

The navigation messages are signals of 50 Hz consisting of data bits describing the orbits of the satellites, clock correction, and other system parameters.

The micro processing module 124 decodes unique codes of the satellites, processes operations of calculating a current location (latitude, longitude, and altitude) on the basis of navigation messages and pseudo distances provided from the signal processing module 123, and transmits the processed results to the map server 140 and the exploring server 150.

The memory 125 stores a control program executed in the micro processing module 124 and temporarily stores a variety of operated data.

The distance information DB server 130 explores a distance information DB according to location information and movement path information of the navigation system 100 to extract map information, distance information, traffic information, traffic signal information, or street status information (e.g., accident status and construction work status). The distance information DB server 130 delivers such information to the map server 140 and the exploring server 150.

The map server 140 includes a geographic feature calculator 142 and a mapping processor 144. The geographic feature calculator 142 receives map information, current location information, and movement path information from the distance information DB server 130, the GPS receiver 120, and the exploring server 150, respectively, to calculate location data on a map. The mapping processor 144 selects a map according to the calculated location data on the map and displays a current location and movement path information on the selected map.

Also, the exploring server 150 includes a path analyzer 151, a weight generator 152, an algorithm pre-processor 153, a genetic algorithm processor 154, and a path selector 155. The exploring server 150 has a function of exploring optimized movement path information using current location information of a user and information for a plurality of intermediate points a user must travel.

An algorithm of exploring optimized movement path information is closely related to so-called a TSP problem (which is also called “NP-complete”). However, it is difficult to solve the TSP problem using a deterministic algorithm on a linear time.

Therefore, according to an embodiment of the present invention, the exploring server 150 calculates optimized movement path information using a genetic algorithm, which is a method for obtaining a solution of a problem using evolution principle of genes.

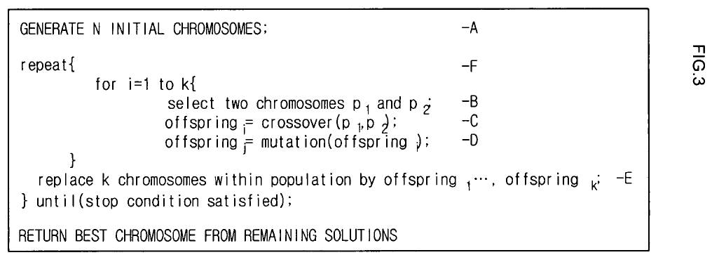

FIG. 3 is a view illustrating an example of pseudo-codes of a genetic algorithm used by an exploring server 150 in a navigation system according to an embodiment of the present invention.

According to the genetic algorithm, n initial chromosomes are selected from existing chromosomes (A), and some of the initial chromosomes are selected by a crossover operator of the chromosomes (B). Subsequently, a crossover is performed on the selected part of the chromosomes (C), so that chromosome mutation having a new character is created (D).

Here, the chromosome is an element that represents a possible candidate solution in the form of a string with respect to a given problem. For example, an element listing respective points according to a travel sequence may be a chromosome.

For example, assuming that six intermediate points that a user must travel are 1, 2, 3, 4, 5, and 6, possible candidate solutions (chromosomes) include 123456, 132456, 142356, 654321, and 643215.

When k new chromosomes (chromosomes of next generation) are created (reconstructed), a process of replacing k chromosomes contained in solution group (i.e., an initial chromosome group) by the k new chromosomes is repeated until a predetermined stop condition is satisfied (F).

Here, the predetermined stop condition may be the number of times the process of creating new chromosomes and replacing the chromosomes contained in the solution group by the created new chromosomes is repeated.

When the predetermined stop condition is satisfied, an optimized solution is selected from the solutions in remaining in the solution group.

The genetic algorithm uses a principle that when meaningful elements existing on chromosomes before reconstruction are conserved even after a crossover operation, chromosomes of high quality remain while a generation progresses.

In the above, a constant k is an amount of solutions replaced at one time in the solution group. Assuming that the number of entire candidate solutions contained in the solution group is n, “k/n” is a ratio by which the candidate solutions contained in the solution group are replaced with new candidate solutions.

Such a genetic algorithm allows a user to obtain an optimized solution using a non-linear (i.e., non-deterministic) method in solving a problem for which a solution cannot be obtained using a deterministic method such as a TSP.

A process of exploring, at the exploring server 150, optimized movement path information using the above-described genetic algorithm will be described in detail.

First, when a plurality of intermediate point information including a plurality of intermediate points a user must travel is inputted through the user interface 110, the path analyzer 151 combines the plurality of intermediate point information to analyze movement path information. The path analyzer 151 analyzes movement path information that can be combined using a weighted graph method.

At this point, the algorithm pre-processor 153 converts the intermediate point information into description of the genetic algorithm. The algorithm pre-processor 153 codes the intermediate point information into a symbol so that the intermediate point information may be operated.

Here, the description means expression using a chromosome. That is, a possible candidate solution is coded using a binary number and expressed in the form of a spring.

Also, the path analyzer 151 receives sequence information between some of intermediate points when receiving the intermediate point information from the user interface. For example, sequence information corresponds to information when a user must sequentially travel some two points, or when a departure point and a destination are determined.

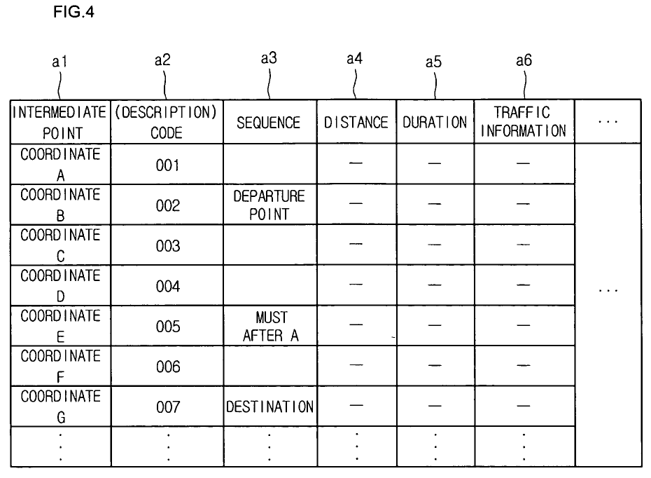

FIG. 4 is a view illustrating an example of a data table generated by an exploring server in a navigation system according to an embodiment of the present invention.

Referring to FIG. 4, intermediate point information a1, description information a2, and sequence information a3 are shown on a table. On the contrary, distance information a4, duration information a5 between intermediate points, and traffic information a6, which are not shown on the table, are shown in the weighted graph method.

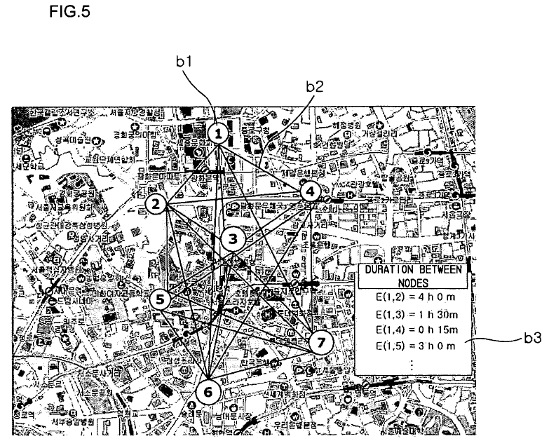

FIG. 5 is a view illustrating an example where the path analyzer analyzes movement path information using a weighted graph method in a navigation system according to an embodiment of the present invention.

Referring to FIG. 5, the path analyzer 151 displays the inputted intermediate point information b1 and displays combined movement path information b2 using the weighted graph method.

Also, the path analyzer 151 may display the intermediate point information b1 that reflects the sequence information and may receive the duration information between the intermediate points from the distance information DB server 130 and analyzing the same, thereby calculating combination type information b3 that corresponds to the movement path information.

When the movement path information is analyzed, the weight generator 152 generates weight information by duration between the intermediate points. At this point, the weight generator 152 may generate the weight information by reflecting the combination type information such as distance information between the intermediate points, traffic information, traffic signal information, and street status information as well as the duration between the intermediate points.

That is, the movement path information and the various combination type information are incorporated into one weight information so that the weight information may be applied to the genetic algorithm.

When the weight information is generated, the algorithm pre-processor 153 combines the symbol-coded intermediate point information to generate initial candidate solutions, which corresponds to the selecting of the initial (parent generation) chromosomes described above.

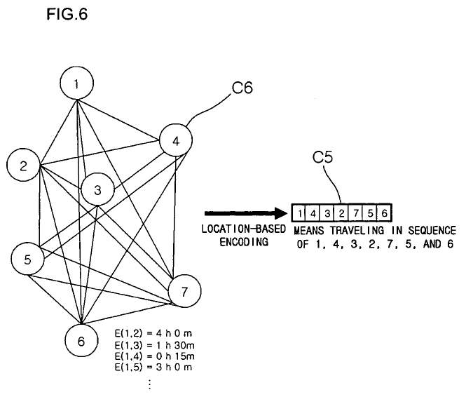

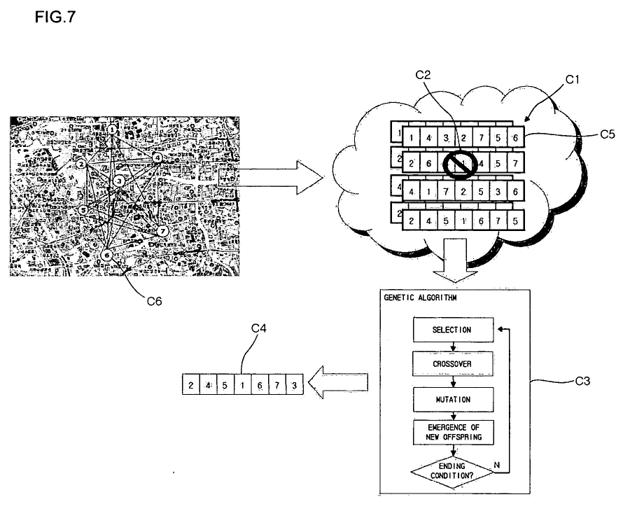

FIG. 6 is a view illustrating an example where an exploring server encoding intermediate point information symbol-coded for location information as a initial solution group on the basis of the location information in the navigation system according to an embodiment of the present invention, and FIG. 7 is an exemplary view illustrating a process for generating, at an exploring server, an initial solution group to apply the genetic algorithm to the initial solution group in a navigation system according to an embodiment of the present invention.

When generating the initial solution group c1, the algorithm pre-processor 153 excludes a candidate solution c2 that has a combination not matched with sequence information between some of the intermediate points.

For example, when a condition that an intermediate point ‘5’ must be traveled after an intermediate point ‘7’ is traveled is set, a candidate solution (e.g., 2631457) having a combination not matched with the above sequence information between the intermediate point ‘5’ and the intermediate point ‘7’, is excluded.

FIGS. 6 and 7 illustrate that a symbol-coded information c5 is generated by symbol-coding one movement path extracted from movement path information c6 analyzed using the weighted graph so that an initial solution group is formed. The initial solution group c1 is generated by repeating such a process.

The genetic algorithm processor 154 performs cycle crossover on a candidate solution contained in the initial solution group to generate a new candidate solution, which is substituted for the candidate solution contained the initial solution group.

The cycle crossover will be described using an example below.

Assuming that a first candidate solution is 12384675 and a second candidate solution is 24135876, a general crossover generates a new candidate solution having intermediate points of a sequence of 12385876 by combining 1238 of the first candidate solution and 5876 of the second candidate solution.

However, according to such a crossover, some of the intermediate points may overlap or may be excluded according to the sequences of the intermediate points contained in the first candidate solution and the second candidate solution.

On the contrary, the cycle crossover is performed in the following way.

Assuming that a first candidate solution is 12348675 and a second candidate solution is 24135876, a first intermediate point 1 is selected first. Then, a new candidate solution has intermediate points consisting of 1XXXXXXX.

When the intermediate point 1 is selected from the first candidate solution, an intermediate point 1 cannot be selected from the second candidate solution. Therefore, an intermediate point 3 of the first candidate solution, which has a location corresponding to that of the intermediate point 1 of the second candidate solution, is selected. Then, a new candidate solution has intermediate points consisting of 1X3XXXXX.

Likewise, when the intermediate point 3 is selected from the first candidate solution, an intermediate point 3 cannot be selected from the second candidate solution. Therefore, an intermediate point 4 of the first candidate solution, which has a location corresponding to that of the intermediate point 3 of the second candidate solution, is selected. Then, a new candidate solution has intermediate points consisting of 1X34XXXX.

Likewise, when the intermediate point 4 is selected from the first candidate solution, an intermediate point 4 cannot be selected from the second candidate solution. Therefore, an intermediate point 2 of the first candidate solution, which has a location corresponding to that of the intermediate point 4 of the second candidate solution, is selected. Then, a new candidate solution has intermediate points consisting of 1234XXXX.

It is possible to reflect an entire cyclic structure generated due to the selecting of 1 as the first intermediate point by performing the above-described process.

After that, 5 is selected from the second candidate solution as a next intermediate point.

A new candidate solution has intermediate points consisting of 12345XXX.

Likewise, when the intermediate point 5 is selected from the second candidate solution, an intermediate point 5 cannot be selected from the first candidate solution. Therefore, an intermediate point 6 of the second candidate solution, which has a location corresponding to that of the intermediate point 5 of the first candidate solution, is selected. Then, a new candidate solution has intermediate points consisting of 12345XX6.

Likewise, when the intermediate point 6 is selected from the second candidate solution, an intermediate point 6 cannot be selected from the first candidate solution. Therefore, an intermediate point 8 of the second candidate solution, which has a location corresponding to that of the intermediate point 6 of the first candidate solution, is selected. Then, a new candidate solution has intermediate points consisting of 123458X6.

It is possible to reflect an entire cyclic structure generated due to the selecting of 5 as the fifth intermediate point by performing the above-described process.

After that, 7 is selected from the first candidate solution as a next intermediate point.

Through the above method, 12345876 may be generated as a new candidate solution.

When the new candidate solution is generated, the genetic algorithm processor 154 sums up weight information between the intermediate points to calculate a character of a candidate solution on which cycle crossover has been performed (c3).

Here, the character is a result obtained when a solution represented by a predetermined chromosome is applied. In an embodiment of the present invention, the character means optimized movement path information (entire duration).

That is, the genetic algorithm processor 154 calculates the movement path information of the new candidate solution.

The genetic algorithm processor 154 repeats operations of sequentially generating and replacing new candidate solutions to judge finally remaining movement path information having a minimum weight information and allows a user to select the candidate solution of the minimum weight information (c4).

When performing the cycle crossover on the candidate solutions contained in the initial solution grout, the genetic algorithm processor 154 sets sequence information between some of the intermediate points as a unit of the cycle crossover. For example, intermediate points containing a determined departure point, destination, and sequence are not excluded when a new candidate solution is generated and substituted for a candidate solution contained in the initial solution grope.

Also, when repeatedly performing the cycle crossover operation, the genetic algorithm processor 154 performs the cycle crossover operation in unit number of times to compare the movement path information and ends the cycle crossover when the movement path information is not improved.

For example, the genetic algorithm processor 154 repeatedly performs the cycle crossover in unit of fifty times and ends the cycle crossover operation when the movement path information is not improved any more.

The path selector 155 selects a candidate solution where summed weight information is minimum from the solution group generated through the repeated operations and decodes the intermediate point information that corresponds to the candidate solution having minimum weight information.

The path selector 155 delivers the decoded intermediate point information (optimized movement path information) to the map server 140, which receives relevant information from the distance information DB server 130 and the GPS server to retransmit the same to the user interface 110.

The user interface 110 displays the movement path information using a graphic screen. At this point, when the user interface 110 includes a voice coding device, the user interface 110 may guide the movement path information using voices.

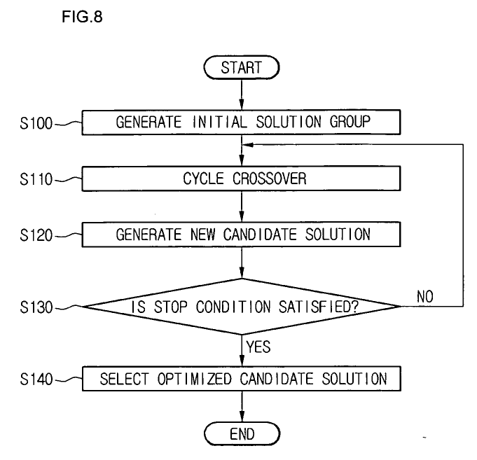

FIG. 8 is a flowchart of a method for selecting a path in a navigation system according to an embodiment of the present invention.

Referring to FIG. 8, a solution group containing at least two candidate solutions that combine a plurality of intermediate points, is generated (S100).

After that, some of the intermediate points contained in the candidate solutions are mutually exchanged, so that a new candidate solution is generated (S100). At this point, a cycle crossover may be used.

Next, a candidate solution contained in the solution group is replaced by the new candidate solution depending on movement path information of the new candidate solution (S120). That is, when it is judged that the new candidate solution has better movement path information than that of the candidate solution contained in the solution group, the candidate solution having poor movement path information is replaced by the new candidate solution.

After the above processes are repeated as much as a predetermined number of times set in advance or repeated until other condition is satisfied, a candidate solution having optimized path information is selected from the candidate solutions contained in the solution group (S130 and S140).

As described above, according to the navigation system for exploring a plurality of intermediate points, a user can travel intermediate points with minimum time and costs when doing his business, moving lots of places.

Also, according to the present invention, even when a user visits a region to which he is not accustomed, a user can received not only a simple service of shortest path between two points but also improved service of optimized movement path information that is explored on the basis of a mathematical algorithm reflecting traffic conditions and road conditions, and is applied to all of intermediate points.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A navigation system comprising:
a path analyzer for combining a plurality of inputted intermediate point information to analyze movement path information;
a weight generator for generating weight information according to a movement duration between intermediate points;
an algorithm pre-processor for combining the intermediate point information to generate an initial solution group;
a genetic algorithm processor for generating a new candidate solution using a candidate contained in the initial solution group and replacing the candidate solution contained in the initial solution group by the new candidate solution depending on movement path information of the new candidate solution; and
a path selector for selecting a candidate solution having optimized movement path information from candidate solutions contained in the solution group.

2. The navigation system according to claim 1, wherein the optimized movement path information is a minimum movement duration.

3. The navigation system according to claim 1, wherein the generation of the new candidate using the candidate solution contained in the initial solution group comprises exchanging some of intermediate points between at least two candidate solutions.

4. The navigation system according to claim 1, wherein the generation of the new candidate using the candidate solution contained in the initial solution group is performed using a cycle crossover method.

5. The navigation system according to claim 1, wherein the genetic algorithm processor repeatedly generates a new candidate solution and replaces the candidate solution contained in the solution group by the new candidate solution until a predetermined stop condition is satisfied.

6. The navigation system according to claim 1, wherein the path analyzer analyzes the movement path information that is combined using a weighted graph method.

7. The navigation system according to claim 1, wherein the plurality of intermediate point information comprises sequence information between some of the intermediate points.

8. The navigation system according to claim 7, wherein the algorithm pre-processor excludes a candidate solution that is not matched with the sequence information between some of the intermediate points when generating the initial solution group.

9. The navigation system according to claim 1, wherein the weight information comprises at least one of distance information between intermediate points, traffic information, traffic signal information, and street status information.

10. The navigation system according to claim 4, wherein the genetic algorithm processor sets the sequence information between some of the intermediate points as a unit of a cycle crossover when performing the cycle crossover on the candidate solution contained in the solution group.

11. A method for selecting a path in a navigation system, the method comprising:
generating a solution group consisting of a plurality of candidate solutions each combining a plurality of intermediate points;
generating a new candidate solution by exchanging some of the intermediate points contained in the candidate solution;
replacing the candidate solution contained in the solution group by the new candidate solution depending on movement path information of the new candidate solution; and
selecting a candidate solution having optimized movement path information from the candidates contained in the solution group.

12. The method according to claim 11, wherein the optimized movement path information is a minimum movement duration.

13. The method according to claim 11, wherein the generating of the new candidate using the candidate solution contained in the initial solution group is performed using a cycle crossover method.

14. The method according to claim 11, wherein the replacing of the candidate solution contained in the solution group by the new candidate solution is repeated until a predetermined stop condition is satisfied.

15. The method according to claim 11, wherein the generating of the solution group comprises excluding a candidate solution that is not matched with sequence information between some of the intermediate points.

16. The method according to claim 11, further comprising, when the weight information of the new candidate solution is smaller than that of the candidate solution contained in the solution group, replacing the candidate solution having the greater weight by the new candidate solution.

17. The method according to the claim 11, wherein the weight information comprises at least one of distance information between intermediate points, traffic information, traffic signal information, and street status information.
